(19) United States
(12) Patent Application Publication
(10) Pub. No.: US 2025/0245900 A1
(43) Pub. Date: Jul. 31, 2025

(54) SCREEN SAVER USER INTERFACE IN CRITICAL ENVIRONMENTS

(71) Applicant: PRICE INDUSTRIES LIMITED, Winnipeg (CA)

(72) Inventors: Christine SAMCHUK, Winnipeg (CA); Matthew NESBITT, Winnipeg (CA); Justen VOGT, Winnipeg (CA); Purva DOLAS, Winnipeg (CA)

(21) Appl. No.: 19/034,253

(22) Filed: Jan. 22, 2025

Related U.S. Application Data
(60) Provisional application No. 63/625,600, filed on Jan. 26, 2024.

(51) Int. Cl. G06T 13/80; G06T 11/00

(52) U.S. Cl. CPC G06T 13/80; G06T 11/001; G06T 2200/24; G06T 2210/62

(57) ABSTRACT

Various embodiments disclose a computer-implemented method comprising identifying a normal status indicator in response to identifying a normal state of a system, rendering the normal status indicator in a first location within the user interface, the normal status indicator comprising a first color at a first color property, rendering a background of the user interface, the background comprising pixels having the first color, wherein the pixels are rendered with a respective color property computed based on a distance from the normal status indicator, and animating the normal status indicator by periodically varying the first color property of the normal status indicator to generate a pulsating effect.

### CROSS REFERENCE TO RELATED APPLICATIONS

This application claims the priority benefit of U.S. Provisional Application No. 63/625,600 entitled, “SCREEN SAVER USER INTERFACE IN CRITICAL ENVIRONMENTS”, filed Jan. 26, 2024. The subject matter of this related application is hereby incorporated herein by reference.

### BACKGROUND

Pressure monitors and other displays in critical spaces such as hospital environments must typically operate in an always-on posture. With monitors and displays employing various types of display technologies, image retention can occur over time, which can degrade the user experience by making the display difficult to read. In critical environments, display readability can be crucial to occupant safety.

### SUMMARY

Various embodiments disclose a computer-implemented method comprising identifying a normal status indicator in response to identifying a normal state of a system, rendering the normal status indicator in a first location within the user interface, the normal status indicator comprising a first color at a first color property, rendering a background of the user interface, the background comprising pixels having the first color, wherein the pixels are rendered with a respective color property computed based on a distance from the normal status indicator, and animating the normal status indicator by periodically varying the first color property of the normal status indicator to generate a pulsating effect.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a computing device according to various embodiments of the present disclosure.

FIG. 2 is an example screen saver user interface according to examples of the disclosure.

FIG. 3 is an example screen saver user interface according to examples of the disclosure.

FIG. 4 is an example screen saver user interface according to examples of the disclosure.

FIG. 5 is a flowchart illustrating one example of functionality implemented as portions of an application executed in a computing device of FIG. 2 according to various embodiments of the present disclosure.

### DETAILED DESCRIPTION

Disclosed are various approaches for displaying information in critical environments while also limiting or preventing screen image retention for devices utilizing LCD, LED, OLED, plasma, and other types of display technology. In critical environments, certain displays show critical information that must always be on and provide continuous indication of a particular piece of information. For example, a display indicating room pressure and whether the pressure is within an acceptable range is often associated with a requirement that the display is always on and continuously displaying whether the room pressure is acceptable or unacceptable. Other variables and parameters can also be indicated by the display and whether a variable or parameter is within an acceptable range. For example, a temperature can be indicated on the display, and the display can further indicate whether the temperature is within an acceptable range. In an environment with properly maintained and functioning equipment, the display often overwhelmingly displays that the pressure in the environment is “OK” or “acceptable.”

Such a dynamic, using conventional display mechanics, can be a recipe for image retention where the LCD crystals or other types display components can become “burnt in” over time and exhibit image retention, ghost imaging, shadow imaging, or other forms of permanent discoloration of the display.

Additionally, in critical environments, users or customers often request or demand that indicators be shown in a high contrast user interface for easier readability and visibility, which can exacerbate the problem of image retention. For example, users or customers might require that white text be utilized against a colored background, or vice-versa, for easy readability by users of the environment. Typical remedies to prevent or limit image retention on a display include turning off the screen after a timeout period or having content on the screen move. However, these solutions degrade the user experience in a critical environment where room status or the status of any parameter should always be available to occupants of users of the room. Additionally, moving an indicator around a display in a user interface degrades readability in a critical environment such as operating rooms where distractions are unwelcome. Therefore, examples of the disclosure provide continuous indication of a parameter, such as temperature, pressure, room status, or any other parameter, while also utilizing an animated indicator that is nearly undetectable by users. The indication of the parameter also limits image retention.

Examples of the disclosure comprise a user interface in which, after period of delay time after a last detected tap, touch, or click on the user interface is detected, a screen saver user interface is executed. The screen saver user interface comprises a low-contrast icon or indicator, such as a checkmark, that also incorporates a fade effect extending radially from the indicator towards the edges of the user interface. The fade effect can comprise a gradual change in a tint of the background color until the color of the background substantially matches that of the indicator.

Additionally, the indicator icon or image can be animated to further limit image retention artifacts. The animation can comprise gradual modification of the opacity of the image or an icon utilized for the indicator such that the indicator appears to gradually fade in and out, thereby preventing or limiting the indicator from causing image retention. In one example, a checkmark can be utilized for the indicator icon or image. The indicator image or icon can be a darker shade or color of the background but a color from the same color family, thereby minimizing contrast between the indicator and background. When the user interface detects user interaction, the screen saver user interface can be terminated and an alternative user interface displayed on the screen.

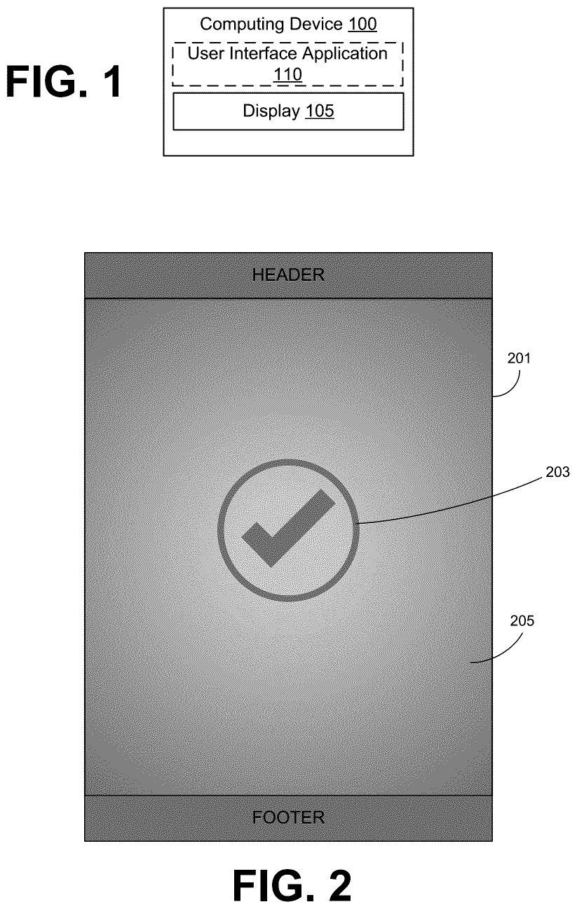

With reference to FIG. 1, shown is computing device 100 according to various examples. The computing device 100 can include one or more processors, memory, and a display 105. In some examples, the computing device 100 can comprise network or local communications interfaces to communicate with other systems. Additionally, the computing device 100 can be a special purpose device such as a room pressure monitor or multi-variable monitor that is installed in a critical environment such as hospitals, operating rooms, isolation rooms, laboratory environments, clean rooms or any other type of environment where monitoring variables such as pressure, room temperature, or other environmental variables is required by the occupants of the environment. Various applications can be executed by the computing device 100. For example, a user interface application 110 can be executed by a processor of the computing device 100 to cause a user interface to be shown on the display 105.

The user interface application 110 can comprise an application that renders a user interface on a display 105. The user interface application 110 can comprise an application that communicates with other systems, sensors, gauges, or computing devices via communications interfaces provided by the computing device 100. For example, the user interface application 110 can comprise an application that determines whether room pressure in a critical space, such as an operating room, isolation room, or other type of environment, is within an acceptable range based upon data obtained from external sensors or sources. The user interface application 110 causes an indicator to be shown on the display 105 that allows occupants of the space or other users monitoring the room pressure to quickly understand whether the room pressure is within a configurable acceptable range based upon the indicator.

The user interface application 110 can display other types of indicators other than room pressure based upon different inputs, sensor data, or other data obtained by the user interface application 110. Additionally, the user interface application 110 can be implemented as a module of an application that determines whether an indicator according to examples of the disclosure should be displayed. If the user interface application 110 determines that an indicator showing that a parameter is within an acceptable range should not be displayed, various other actions can be taken, such as displaying and/or communicating an alert message.

Referring next to FIG. 2, shown is an example screen saver user interface 201 that can be generated by the user interface application 110 and shown on a display 105 of the computing device 100. In the example of FIG. 2, the screen saver user interface 201 can incorporate an indicator 203, also referred to herein as a normal status indicator. The indicator 203 can comprise an icon or image that can be displayed to communicate information to a user. In the example of FIG. 2, the indicator 203 is a checkmark that is colored green, which can indicate that a parameter, such as room pressure, is within an acceptable range.

The indicator 203 is rendered overlaid onto a background 205. The background 205 is rendered such that the color of the background 205 can be the same or similar to the color chosen for the indicator 203. The background 205 can incorporate a gradient that extends radially from the center of the screen saver user interface 201. The gradient can be generated by varying the transparency of the background color. At the center of the screen saver user interface 201, a higher transparency level of the background 205 is selected. The transparency level of the background 205 gradually decreases radially towards the edges of the screen saver user interface 201. In other words, the user interface application 110 computes a transparency level of respective pixels of the background 205 based on a distance from a center of the user interface 201 or from the indicator 203. The transparency of pixels in the background 205 can be higher closer to the indicator 203 or to the center of the user interface 201 than at the edges of the background 205, which are farther away from the indicator 203. In one embodiment, the transparency of pixels is selected such that the closer a pixel is to the center of the user interface 201 or to the indicator 203, the higher the transparency of the pixel subject to a maximum transparency threshold. In this embodiment, the transparency of the pixels is reduced the further away a pixel is from the center of the user interface 201 or from the indicator 203, subject to a minimum transparency threshold. The maximum transparency threshold can be set at a level where full transparency is utilized or at any level below that so that the color of the background 205 is visible. The minimum transparency threshold can be set at a level where there is zero transparency or at any level above that so that the color of the background 205 is visible.

In alternative implementations, the indicator 203 can be placed in a location of the screen saver user interface 201 other than the center of the screen saver user interface 201. In this scenario, the transparency of respective pixels of the background 205 are selected so that they are higher the closer a pixel is to the indicator 203 and lower the farther away a pixel is from the indicator 203.

By employing a gradient that varies transparency of the background 205, the screen saver user interface 201 can be configured such that the same or similar color is chosen for the indicator 203 and background 205 while still making the indicator 203 visible to the user within the screen saver user interface 201. Additionally, by employing a color gradient using the same color, contrast between the indicator 203 and background 205 is minimized, thereby reducing the likelihood of causing image retention or other damage to the display 105 of the computing device 100.

In alternative implementations, rather than employing a gradient in which transparency is varied, other color properties can be gradually varied, such as a tint, shade, or tone of the color of the indicator 203 or background 205. In these alternative implementations, the background 205 can also incorporate a gradient that extends radially from the center of the screen saver user interface 201. The gradient can be generated by varying a color property of the background color, such as tint, shade, or tone. For example, the color property varies gradually for pixels based upon a distance of respective pixels from the center of the user interface 201 or from the indicator 203. In some examples, a gradient effect is achieved by selecting a different color for pixels based on a distance of the pixels from the center of the user interface 201 or from the indicator 203. For example, the color of pixels is selected so that the contrast of the color for pixels that are farther away from the center of the user interface 201 or the indicator 203 is greater than pixels that are closer to the enter of the user interface 201 or the indicator. The color of a pixel is chosen by selecting an RGB value that is based upon the location of the pixel within the user interface 201. Pixels that are closer to the center or to the indicator 203 are configured with an RGB value that contrasts less with the color of the indicator 203 than pixels farther from the center or from the indicator 203.

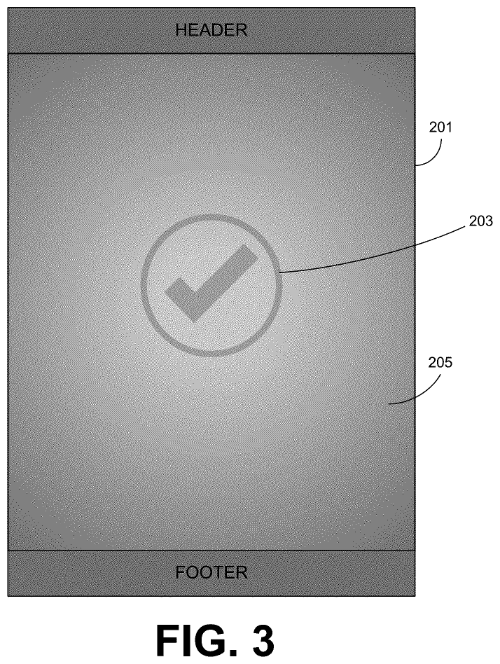

Additionally, in some examples of the disclosure, the indicator 203 can be subtly animated to further reduce the possibility of image retention on the display 105 of the computing device 100. Reference is made to FIG. 3, which continues the example of FIG. 2 and illustrates such an animation. The user interface application 110 can animate the user interface by modifying the transparency level of the indicator 203 shown against the background 205. The transparency level can be modified in a looping fashion such that the transparency level is repeatedly raised and lowered from a maximum value to a minimum value repeatedly over a given time period. The animation can give the indicator 203 a pulsating appearance. FIG. 3 illustrates an example of how the transparency level of an image or icon used for the indicator 203 can be increased but to a minimum threshold level such that the indicator 203 remains visible in the user interface 201. By animating the transparency level of the image or icon used for the indicator 203, the user interface application 110 can limit the possibility of screen damage to the display 105 while ensuring that the indicator 203 is always visible to the user, which can be an important factor in critical environments.

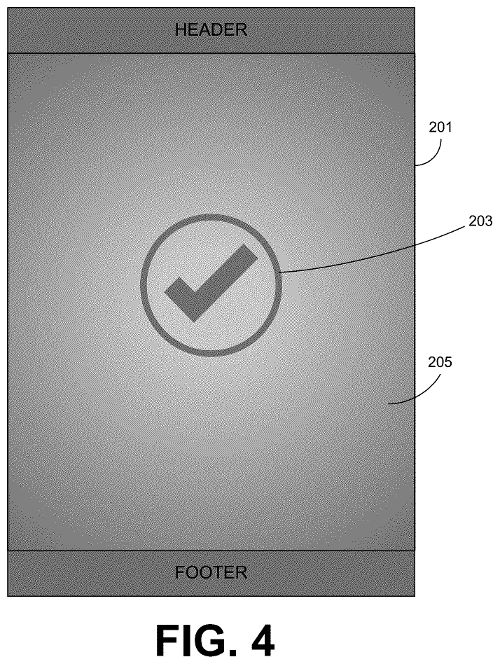

Continuing the example of FIG. 3, reference is now made to FIG. 4. In FIG. 4, the user interface application 110 is continuing to animate the indicator 203 by varying a color property of the indicator 203, such as the transparency level, or alpha, of the indicator 203 or a color that is selected for the indicator 203. In the example of FIG. 4, the transparency of the image or icon selected for the indicator 203 is lower relative to the example of FIG. 3, thereby making the indicator 203 a darker shade of the color chosen for the indicator 203.

By animating the indicator 203 by varying the transparency or another color property of the indicator 203, the indicator 203 remains visible within the screen saver user interface 201. Additionally, by animating the indicator 203, examples of the disclosure are implemented such that the position or location of the indicator 203 does not change, which can be visually distracting to users in a critical environment. Instead, examples of the disclosure produce a more subtle animation that can mitigate damage to the display 105 of the computing device 100 while still continuously displaying critical information in a critical environment on the display 105.

Accordingly, the user interface application 110 can generate the animation by gradually cycling the transparency of the indicator 203 from a minimum to a maximum level over a selected time period, such as between the examples shown in FIG. 2 to FIG. 3, and then back to the example of FIG. 2, and so on.

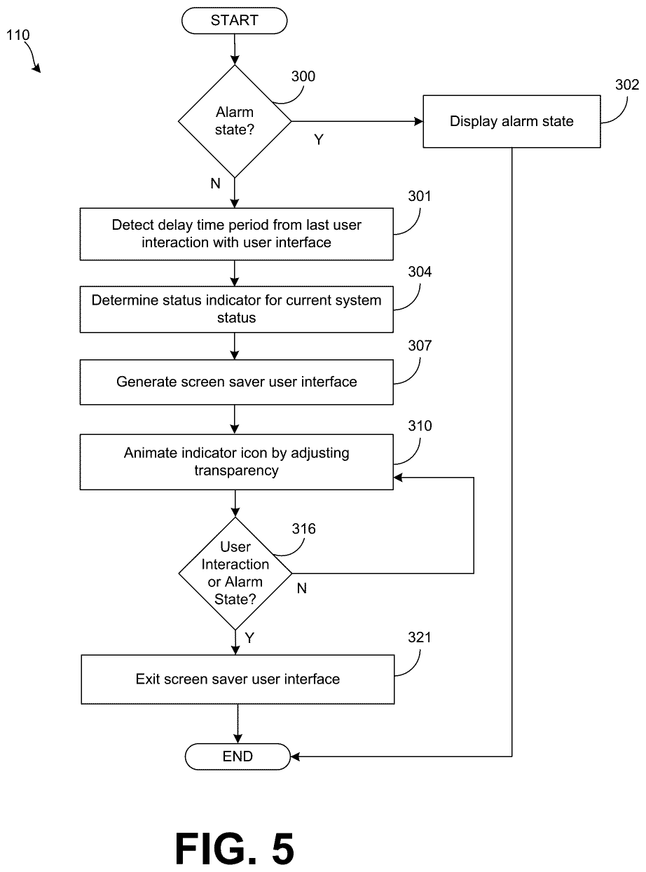

Referring next to FIG. 5, shown is a flowchart that provides one example of the operation of a portion of the user interface application 110. The flowchart of FIG. 5 provides merely an example of the many different types of functional arrangements that can be employed to implement the operation of the depicted portion of the user interface application 110. As an alternative, the flowchart of FIG. 5 can be viewed as depicting an example of elements of a method implemented within the computing device 100.

First, at step 300, user interface application 110 determines whether an alarm state is present. An alarm state is present if a parameter that is being monitored by the user interface application 110 is outside of a normal value range. For example, if the barometric pressure of a room is outside of an acceptable normal range, the user interface application 110 determines that an alarm state exists and proceeds to step 301. If the monitored variable is within the acceptable normal range, the user interface application 110 determines that an alarm state does not exist and proceeds to step 302.

At step 301, the user interface application 110 displays a user interface indicating an alarm state on the display 105. The alarm state indication can be coupled with audible indicators played back by computing device 100 via one or more speakers. In some examples, the user interface application 110 can also transmit an alert or indication of the alarm state to another computing device, such as a monitoring system or devices associated with one or more users who can address or correct the alarm state.

At step 302, if the user interface application 110 does not determine that an alarm state is present, the user interface application 110 detects that a delay time period has elapsed from a last user interaction with the user interface. In other words, the user interface application 110 detects that the user interface is idle such that a screen saver user interface 201 should be displayed on the display 105.

At step 304, the user interface application 110 determines a status indicator to display within the screen saver user interface 201. The user interface application 110 determines whether a variable or value is within an acceptable range such that the indicator 203 should be shown within the screen saver user interface 201.

At step 307, the user interface application 110 can generate the screen saver user interface 201. The screen saver user interface 201 can be generated by overlaying the indicator 203 over a background 205 that utilizes a gradient that varies transparency or another color property. For example, as noted above, the transparency or alpha of the color chosen from the background is higher closer to where the indicator 203 is placed or to the center of the screen saver user interface 201 and is lowered farther away from where the indicator 203 is placed or farther from the center of the screen saver user interface 201. By increasing transparency of the background 205 closer to the indicator 203, the indicator 203 is more visible to the user within the screen saver user interface 201. As another example, the color of pixels can be varied based upon the distance of the pixel from the center of the user interface 201 or from the indicator 203. The color of pixels can be chosen so that a gradient effect is achieved by varying the color of the pixels based upon its location in the user interface 201.

At step 310, the user interface application 110 animates the background 205 by varying a transparency of the icon or image selected as the indicator 203 within the screen saver user interface 201. The transparency or another color property of the indicator 203 can be varied in a repeated looping fashion such that the indicator 203 appears to pulsate. For example, a minimum transparency of the indicator 203 can be selected such that the indicator 203 is never completely transparent and therefore never completely disappears from the screen saver user interface 201.

At step 316, the user interface application 110 determines whether a user interaction with the screen saver user interface 201 has occurred, such as a tap, mouse click, button press, or other user input to the screen saver user interface 201. If no user interaction has occurred, the process can return to step 310, where the user interface application 110 continues to animate the indicator 203 within the screen saver user interface 201.

If a user interaction with the screen saver user interface 201 is detected at step 316 or an alarm state is detected, the process proceeds to step 321, where the user interface application 110 exits the screen saver user interface 201. The user interface application 110 can display other menus or user interface elements with which the user interface application 110 is instrumented to show when a screen saver is not required. Thereafter, the process can proceed to completion. The process can be repeated by returning to step 300, where the user interface application 110 detects whether there is an alarm state.

1. In some embodiments, a computer-implemented method for rendering a user interface on a display comprises identifying a normal status indicator in response to identifying a normal state of a system, rendering the normal status indicator in a first location within the user interface, the normal status indicator comprising a first color with a first color property, rendering a background of the user interface, the background comprising pixels having the first color, wherein the pixels are rendered with a respective color property computed based on a distance from the normal status indicator, and animating the normal status indicator by periodically varying the first color property of the normal status indicator to generate a pulsating effect.

2. The computer-implemented method of clause 1, wherein rendering the background of the user interface further comprises selecting the respective color property of a first respective pixel at a first distance from a center of the normal status indicator higher than the respective color property of a second respective pixel that is farther away from the center of the normal status indicator than the first distance.

3. The computer-implemented method of clauses 1 or 2, wherein rendering the background of the user interface further comprises setting the respective color property of the pixels adjacent to an edge of the user interface different from the respective color property adjacent to the normal status indicator.

4. The computer-implemented method of any of clauses 1-3, wherein rendering the background of the user interface further comprises applying a radially extending fade effect from the normal status indicator, wherein a first pixel that is closer to a center of the normal status indicator has a first color property and a second pixel that is farther from the center of the normal status indicator has a second color property.

5. The computer-implemented method of any of clauses 1-4, wherein the first color property comprises a first transparency level and the second color property comprises a second transparency level, wherein the first transparency level is higher than the second transparency level.

6. The computer-implemented method of any of clauses 1-5, further comprising, in response to detecting an alarm state of the system, replacing the user interface on the display with an alarm state user interface.

7. The computer-implemented method of any of clauses 1-6, wherein animating the normal status indicator further comprises varying the first color property of an image comprising the normal status indicator between a minimum color property threshold and a maximum color property threshold.

8. The computer-implemented method of any of clauses 1-7, wherein the maximum color property threshold causes the image to be less visible than the minimum color property threshold.

9. The computer-implemented method of any of clauses 1-8, further comprising rendering the normal status indicator and the background after detecting a delay period from a last user interaction with the user interface.

10. The computer-implemented method of any of clauses 1-9, wherein the color property comprises a transparency level or a selected color.

11. The computer-implemented method of any of clauses 1-10, wherein the selected color is different from the first color when the pixel is a threshold distance from the normal status indicator.

12. The computer-implemented of any of clauses 1-11, further comprising selecting the selected color based upon a degree of contrast from the first color.

13. In some embodiments, one or more non-transitory computer-readable media store instructions that, when executed by one or more processors to render a user interface on a display, cause the one or more processors to perform the steps of identifying a normal status indicator in response to identifying a normal state of a system, rendering the normal status indicator in a first location within the user interface, the normal status indicator comprising a first color at a first color property, rendering a background of the user interface, the background comprising pixels having the first color, wherein the pixels are rendered with a respective color property computed based on a distance from the normal status indicator, and animating the normal status indicator by periodically varying the first color property of the normal status indicator to generate a pulsating effect.

14. The one or more non-transitory computer-readable media of clause 13, wherein rendering the background of the user interface further comprises selecting the respective color property of a first respective pixel at a first distance from a center of the normal status indicator different from the respective color property of a second respective pixel that is farther away from the center of the normal status indicator than the first distance.

15. The one or more non-transitory computer-readable media of clauses 13 or 14, wherein rendering the background of the user interface further comprises setting the respective color property of the pixels adjacent to an edge of the user interface different from the respective color property adjacent to the normal status indicator.

16. The one or more non-transitory computer-readable media of any of clauses 13-15, wherein rendering the background of the user interface further comprises applying a radially extending fade effect from the normal status indicator, wherein a first pixel that is closer to a center of the normal status indicator has a first color property and a second pixel that is farther from the center of the normal status indicator has a second color property

17. The one or more non-transitory computer-readable media of any of clauses 13-16, further comprising, in response to detecting an alarm state of the system, replacing the user interface on the display with an alarm state user interface.

18. The one or more non-transitory computer-readable media of any of clauses 13-17, wherein animating the normal status indicator further comprises varying the first color property of an image comprising the normal status indicator between a minimum color property threshold and a maximum color property threshold.

19. The one or more non-transitory computer-readable media of any of clauses 13-18, wherein the maximum color property threshold causes the image to be less visible than the minimum color property threshold.

20. The one or more non-transitory computer-readable media of any of clauses 13-19, further comprising rendering the normal status indicator and the background after detecting a delay period from a last user interaction with the user interface.

21. In some embodiments, a system comprises a display, a memory, and a processor coupled to the memory that executes a user interface application that renders a user interface on the display by performing the steps of identifying a normal status indicator in response to identifying a normal state of a system, rendering the normal status indicator in a first location within the user interface, the normal status indicator comprising a first color at a first transparency level, rendering a background of the user interface, the background comprising pixels having the first color, wherein the pixels are rendered with a respective transparency level computed based on a distance from the normal status indicator, and animating the normal status indicator by periodically varying the first transparency level of the normal status indicator to generate a pulsating effect.

22. The system of clause 21, wherein rendering the background of the user interface further comprises selecting the respective transparency level of a first respective pixel at a first distance from a center of the normal status indicator higher than the respective transparency level of a second respective pixel that is farther away from the center of the normal status indicator than the first distance.

23. The system of clauses 21 or 22, wherein rendering the background of the user interface further comprises setting the respective transparency level of the pixels adjacent to an edge of the user interface lower than the respective transparency level adjacent to the normal status indicator.

24. The system of any of clauses 21-23, wherein rendering the background of the user interface further comprises applying a radially extending fade effect from the normal status indicator, wherein a first pixel that is closer to a center of the normal status indicator has a higher transparency level than a second pixel that is farther from the center of the normal status indicator.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart shows the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowchart shows a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowchart can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Various embodiments of the present disclosure are described in the following clauses. Although the following clauses describe some embodiments of the present disclosure, other embodiments of the present disclosure are also set forth above.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for rendering a user interface on a display, comprising:
identifying a normal status indicator in response to identifying a normal state of a system;
rendering the normal status indicator in a first location within the user interface, the normal status indicator comprising a first color with a first color property;
rendering a background of the user interface, the background comprising pixels having the first color, wherein the pixels are rendered with a respective color property computed based on a distance from the normal status indicator; and
animating the normal status indicator by periodically varying the first color property of the normal status indicator to generate a pulsating effect.

2. The computer-implemented method of claim 1, wherein rendering the background of the user interface further comprises selecting the respective color property of a first respective pixel at a first distance from a center of the normal status indicator higher than the respective color property of a second respective pixel that is farther away from the center of the normal status indicator than the first distance.

3. The computer-implemented method of claim 1, wherein rendering the background of the user interface further comprises setting the respective color property of the pixels adjacent to an edge of the user interface different from the respective color property adjacent to the normal status indicator.

4. The computer-implemented method of claim 1, wherein rendering the background of the user interface further comprises applying a radially extending fade effect from the normal status indicator, wherein a first pixel that is closer to a center of the normal status indicator has a first color property and a second pixel that is farther from the center of the normal status indicator has a second color property.

5. The computer-implemented method of claim 4, wherein the first color property comprises a first transparency level and the second color property comprises a second transparency level, wherein the first transparency level is higher than the second transparency level.

6. The computer-implemented method of claim 1, further comprising, in response to detecting an alarm state of the system, replacing the user interface on the display with an alarm state user interface.

7. The computer-implemented method of claim 1, wherein animating the normal status indicator further comprises varying the first color property of an image comprising the normal status indicator between a minimum color property threshold and a maximum color property threshold.

8. The computer-implemented method of claim 6, wherein the maximum color property threshold causes the image to be less visible than the minimum color property threshold.

9. The computer-implemented method of claim 1, further comprising rendering the normal status indicator and the background after detecting a delay period from a last user interaction with the user interface.

10. The computer-implemented method of claim 1, wherein the color property comprises a transparency level or a selected color.

11. The computer-implemented method of claim 10, wherein the selected color is different from the first color when the pixel is a threshold distance from the normal status indicator.

12. The computer-implemented of claim 10, further comprising selecting the selected color based upon a degree of contrast from the first color.

13. One or more non-transitory computer-readable media storing instructions that, when executed by one or more processors to render a user interface on a display, cause the one or more processors to perform the steps of:
identifying a normal status indicator in response to identifying a normal state of a system;
rendering the normal status indicator in a first location within the user interface, the normal status indicator comprising a first color at a first color property;
rendering a background of the user interface, the background comprising pixels having the first color, wherein the pixels are rendered with a respective color property computed based on a distance from the normal status indicator; and
animating the normal status indicator by periodically varying the first color property of the normal status indicator to generate a pulsating effect.

14. The one or more non-transitory computer-readable media of claim 13, wherein rendering the background of the user interface further comprises selecting the respective color property of a first respective pixel at a first distance from a center of the normal status indicator different from the respective color property of a second respective pixel that is farther away from the center of the normal status indicator than the first distance.

15. The one or more non-transitory computer-readable media of claim 13, wherein rendering the background of the user interface further comprises setting the respective color property of the pixels adjacent to an edge of the user interface different from the respective color property adjacent to the normal status indicator.

16. The one or more non-transitory computer-readable media of claim 13, wherein rendering the background of the user interface further comprises applying a radially extending fade effect from the normal status indicator, wherein a first pixel that is closer to a center of the normal status indicator has a first color property and a second pixel that is farther from the center of the normal status indicator has a second color property.

17. The one or more non-transitory computer-readable media of claim 13, further comprising, in response to detecting an alarm state of the system, replacing the user interface on the display with an alarm state user interface.

18. The one or more non-transitory computer-readable media of claim 13, wherein animating the normal status indicator further comprises varying the first color property of an image comprising the normal status indicator between a minimum color property threshold and a maximum color property threshold.

19. The one or more non-transitory computer-readable media of claim 18, wherein the maximum color property threshold causes the image to be less visible than the minimum color property threshold.

20. The one or more non-transitory computer-readable media of claim 13, further comprising rendering the normal status indicator and the background after detecting a delay period from a last user interaction with the user interface.

21. A system comprising:
a display;
a memory; and
a processor coupled to the memory that executes a user interface application that renders a user interface on the display by performing the steps of:
identifying a normal status indicator in response to identifying a normal state of a system;
rendering the normal status indicator in a first location within the user interface, the normal status indicator comprising a first color at a first transparency level;
rendering a background of the user interface, the background comprising pixels having the first color, wherein the pixels are rendered with a respective transparency level computed based on a distance from the normal status indicator; and
animating the normal status indicator by periodically varying the first transparency level of the normal status indicator to generate a pulsating effect.

22. The system of claim 21, wherein rendering the background of the user interface further comprises selecting the respective transparency level of a first respective pixel at a first distance from a center of the normal status indicator higher than the respective transparency level of a second respective pixel that is farther away from the center of the normal status indicator than the first distance.

23. The system of claim 21, wherein rendering the background of the user interface further comprises setting the respective transparency level of the pixels adjacent to an edge of the user interface lower than the respective transparency level adjacent to the normal status indicator.

24. The system of claim 21, wherein rendering the background of the user interface further comprises applying a radially extending fade effect from the normal status indicator, wherein a first pixel that is closer to a center of the normal status indicator has a higher transparency level than a second pixel that is farther from the center of the normal status indicator.
